(19) United States
(12) Patent Application Publication
(10) Pub. No.: US 2008/0296293 A1
(43) Pub. Date: Dec. 4, 2008

(54) VOC waste gas microwave burning furnace

(76) Inventor: Chuan-Line Tseng, Chang Hua (TW)

Correspondence Address: BIRCH STEWART KOLASCH & BIRCH, PO BOX 747, FALLS CHURCH, VA, 22040-0747, US

(21) Appl. No.: 11/806,793

(22) Filed: Jun. 4, 2007

(51) Int. Cl. H05B 6/80

(52) U.S. Cl. 219/687; 219/761

(57) ABSTRACT

A VOC waste gas microwave burning furnace uses nano titanium dioxide as a catalyst, which is coated on a carrier substance, such as an activated carbon. The titanium dioxide coated carrier substance is charged in a plurality of refractory ceramic/glass tubes arranged in a carrier in a reaction tank of the burning furnace. When the refractory ceramic/glass tubes are irradiated by microwave generated by a magnetron type microwave generator, the carrier substance charged therein has an increased high dielectric constant to increase the microwave effect, and the catalyst of titanium dioxide is excited to produce high-energy free radicals and electron-hole pairs. Therefore, the magnetron type microwave generator may generate non-ionizing radiative microwave energy, which causes ion transfer and dipole rotation to achieve movement of target molecules, and accordingly, to destroy and decompose target pollutants, that is, the organic gas in industrial waste gas.

### FIELD OF THE INVENTION

The present invention relates to a VOC waste gas microwave burning furnace, and more particularly, to a burning furnace that does not consume oil while providing high working efficiency, and may be easily assembled at reduced cost to provide safe use thereof.

### BACKGROUND OF THE INVENTION

There are numerous different organic pollutants existed in the atmosphere. Among others, volatile organic compounds (VOC) are the most widely existing organic pollutants in our living environment because they can be produced from a wide range of sources from oil refining plants to dry cleaning stores, electronic plants, surface treatment factories, leather manufacturers, paint factories, and chemical plants. Most organic gas from these sources is volatile and chemically toxic to have adverse influences on human body, and is therefore potentially hazardous to health. In the Clean Air Act Amendments of 1990 passed by the United States Congress in 1990, a plurality of volatile organic compounds is classified as toxic atmospheric pollutants. Some common ways for controlling toxic gas include, for example, burning, catalytic incinerating, adsorbing with activated carbon, wet scrubbing, condensing, photo-oxidizing, bio-treatment, and some advanced oxidation processes.

While the thermal treatment and some advanced oxidation processes may effectively destroy and remove the organic waste gas, they require extremely high cost in early phase of investment. The adsorption and absorption of waste gas can only transfer the toxic gas to another place without actually achieving the goal of reducing the amount and toxicity of environmental pollutants. Therefore, it is an important contemporary issue to find out a high-efficient and cost-effective technique for treating VOC waste gas.

### SUMMARY OF THE INVENTION

A primary object of the present invention is to provide an improved VOC waste gas microwave burning furnace to overcome the high cost problem as existed in the conventional waste gas treatment facilities.

To achieve the above and other objects, the VOC waste gas microwave burning furnace according to the present invention includes a reaction rank having at least one carrier mounted therein. The carrier is internally mounted at least one irradiation chamber, a magnetron type microwave generator, and a plurality of refractory ceramic/glass tubes, which are charged with a filler material and orderly arranged in the irradiation chamber. The magnetron type microwave generator generates microwave energy, causing organic industrial waste gas flown through the refractory ceramic/glass tubes to be destroyed and decomposed, so that the VOC waste gas microwave burning furnace of the present invention does not consume oil while providing high working efficiency, and is easy to assemble at reduced cost, and safe for use.

The reaction tank and other related apparatus of the present invention consist of ceramic/glass tubes, which can withstand a temperature as high as 1200° C., and other related high-temperature elements, such as k-type temperature sensor, carbon monoxide and carbon dioxide detectors, gas flow meter, electron recorder, air compressor, motor, gas valve, conveying pipe, etc.

In the present invention, the filler material charged in the refractory ceramic/glass tubes is a catalyst consisting of nano titanium dioxide, which is coated on activated carbon or other carrier substances having a high dielectric constant. With the filler material charged in the refractory ceramic/glass tubes and the microwave reaction system, the carrier substance has increased dielectric constant to increase the microwave effect. Moreover, the microwave energy generated by the magnetron type microwave generator excites the catalyst of titanium dioxide to produce high-energy free radicals and electron-hole pairs for treating volatile organic gas/pollutants contained in air.

The VOC waste gas microwave burning furnace of the present invention achieves at least the following functions:
1. It combines two highly advanced treating techniques, namely, nano photocatalyst and magnetized microwave, to effectively and quickly decompose organic gas/pollutants to reduce their pollution and hazards to environment and human.
2. It needs only very short reaction time to destroy and decompose the organic gas/pollutants, and the emissions thereof include non-hazardous carbon dioxide and water. Therefore, the present invention has low power consumption and does not cause secondary public hazards.
3. It has short reaction time to allow a relatively small reaction tank, which can be easily assembled at reduced erection and handling costs, and is therefore affordable by general small-scale plants without increasing the plant burdens.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic view showing the connection of a reaction tank of a VOC waste gas microwave burning furnace of the present invention to other related facilities;

FIG. 2 shows a carrier of the present invention is internally mounted a magnetron type microwave generator, an irradiation chamber, and a filler-charged refractory ceramic/glass tubes;

FIG. 3 schematically shows the carrier of the present invention is provided with legs, a gas inlet, and a gas outlet; and

FIG. 4 schematically shows the magnetron type microwave generator of the present invention generates microwave to irradiate the refractory ceramic/glass tubes mounted in the carrier.

### DETAILED DESCRIPTION OF THE PREFERRED EMBODIMENTS

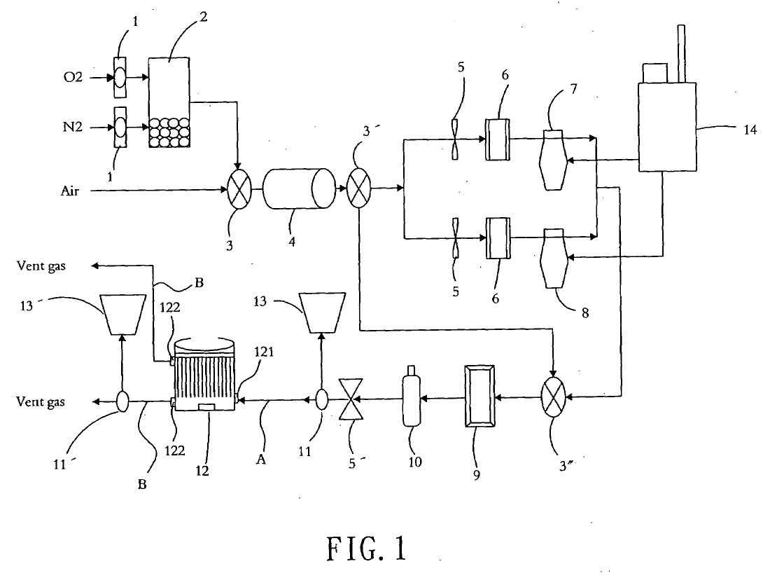

Please refer to FIG. 1 that schematically shows the connection of a reaction tank 12 of the present invention to other related facilities. As shown, different types of gas, such as oxygen (O₂) and nitrogen (N₂), are separately passed through a flow meter 1 into a gas mixing tank 2, which is connected to an end of a filter 4 via a valve 3, via which air may be introduced into the filter 4. The filter 4 is connected at an opposite end to a valve 3′.

The gas mixture flown through the filter 4 passes through the valve 3, and diverges into two branches to separately flow through one of two paths, a first one of which sequentially includes a first valve 5, a flow controller 6, and a supply of organic waste gas 7, and a second of which sequentially includes a second valve 5, a flow controller 6, and a humidity controller 8. The two branches of the gas mixture converge after they have passed the two paths, and the converged gas mixture keeps flowing to a valve 3″. Alternatively, the gas mixture passed through the valve 3′ may be directly guided to the valve 3″. A cooling system 14 may be connected to the organic waste gas 7 and the humidity controller 8 to monitor and control the supply of the organic waste gas 7 and the operation of the humidity controller 8.

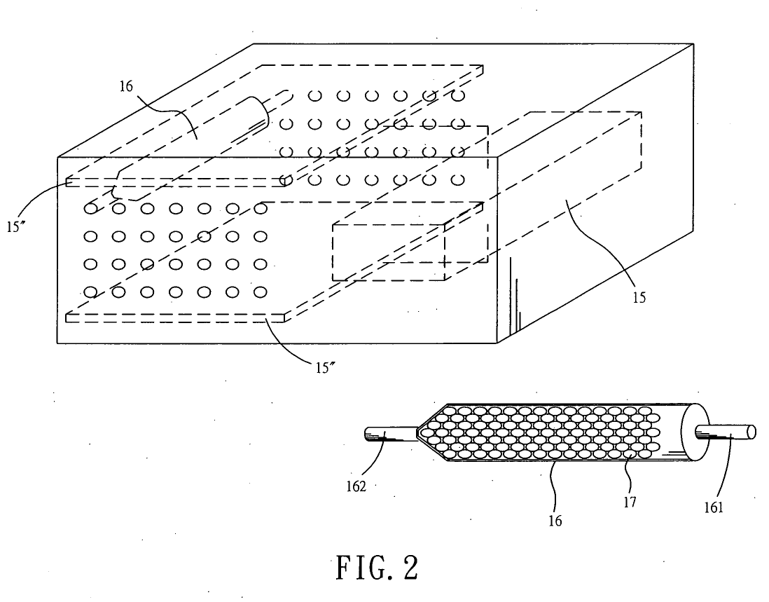

The gas mixture flown to the valve 3″ then sequentially flows through a mass flow meter 9, a temperature controller 10, and a sampling valve 11. A valve 5′ is provided between the temperature controller 10 and the sampling valve 11, and the sampling valve 11 is connected to a computerized recording and controlling apparatus 13 for monitoring and controlling the sampling valve 11. The gas mixture then flows from the sampling valve 11 through a conveying pipe A into a reaction tank 12 via an inlet 121 thereof. In the reaction tank 12, there is provided at least one magnetron type microwave generator 15, which generates microwave to irradiate a filler material 17 shown in FIG. 2, so that the filler material 17 produces high-energy free radicals and electron-hole pairs, resulting in a quick high-temperature effect to raise the room temperature to a temperature as high as 1100° C. At this point, the organic waste gas 7 passed through the filler material 17 is completely destroyed and decomposed to produce a non-hazardous gas.

The produced non-hazardous gas flows out of the reaction tank 12 via an outlet 122 provided near an upper end of the reaction tank 12, and into an emission pipe B. Alternatively, the reaction tank 12 is provided near a lower end with a lower emission pipe B, which is provided at a terminal end with a sampling valve 11′. Again, the sampling valve 11′ may be connected to a computerized recording and controlling apparatus 13′ for monitoring and controlling the sampling valve 11′.

Please refer to FIG. 2, which shows a carrier 21 of the present invention is internally mounted the magnetron type microwave generator 15, irradiation chambers 15″, and many filler-charged refractory ceramic/glass tubes 16. As shown, the carrier 21 is internally mounted a plurality of irradiation chambers 15″, in which a plurality of refractory ceramic/glass tubes 16 is arranged. The refractory ceramic glass/tubes 16 are made of refractory precision ceramic/glass tubes and charged with a filler material 17. Basically, the filler material 17 provides a catalytic action and is charged into a whole inner space of each of the refractory ceramic/glass tubes 16. Each of the refractory ceramic/glass tubes 16 has an inlet end 161 correspondingly connected to the conveying pipe A, and an outlet end 162 to the emission pipe B.

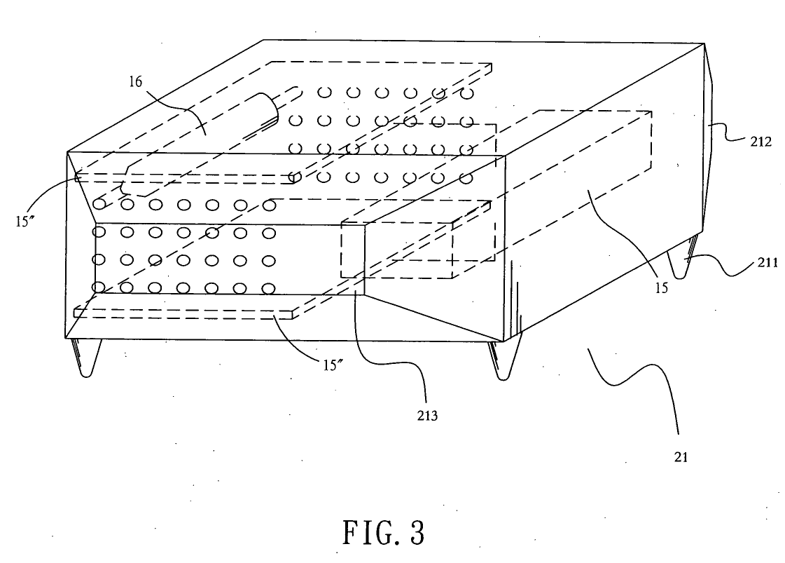

FIG. 3 shows the carrier 21 of the present invention is provided at a bottom with a plurality of downward extended legs 211, and at predetermined positions with a gas inlet 212 and a gas outlet 213. The gas inlet 212 corresponds to the inlet 121 of the reaction tank 12, and the gas outlet 213 to the outlet 122 of the reaction tank 12. For the purpose of achieving the best efficiency, a plurality of carriers 21 may be provided depending on actual need, and stacked in the reaction tank 12.

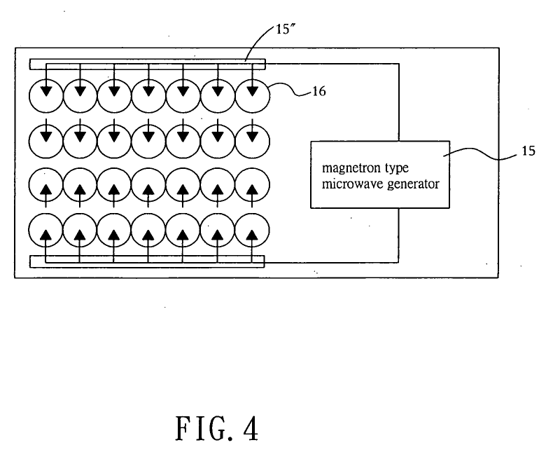

FIG. 4 shows the magnetron type microwave generator 15 of the present invention generates microwave to irradiate the refractory ceramic/glass tubes 16 mounted in the carrier 21 of FIG. 2. Due to a microwave irradiation effect, the filler material 17 in the refractory ceramic/glass tubes 16 produces high-energy free radicals and electron-hole pairs, resulting in a quick high-temperature effect to raise the room temperature to a temperature as high as 1100° C., so that organic waste gas 7 passed through the filler material 17 is completely destroyed and decomposed to produce a non-hazardous gas.

In the following paragraph, many described elements are not shown in the drawings.

In the present invention, the filler material 17 as shown in FIG. 2 is obtained by positioning a prepared titanium-containing solution in a vacuum evaporator, and adding an appropriate amount of adsorbent into the solution; evenly stirring the mixture of the solution and the adsorbent, and then adding pure water into the mixture to hydrolyze titanium tetraisopropoxide (TIPO); keeping stirring for one hour, and allowing the solution to vaporize to obtain granulated TiO₂/adsorbent; and calcining the granulated TiO₂/adsorbent at high temperature to give the same an increase bonding strength. The filler material 17 may be then analyzed using an XDR diffraction meter and a scanning electron microscope (SEM) to check the crystal form and crystal size of the catalyst so prepared, and measured using a BET (Brunauer Emmett and Teller) surface area analyzer to observe changes in the BET surface area, the porosity, and the crystal size of the adsorbent in the manufacturing process, as well as changes of zeta potential on the surface of the adsorbent.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A VOC waste gas microwave burning furnace, comprising a reaction chamber, in which at least one carrier is provided; the carrier being internally mounted a magnetron type microwave generator, a plurality of irradiation chambers, and a plurality of refractory ceramic/glass tubes, which are arranged in the irradiation chambers and charged with a filler material.

2. The VOC waste gas microwave burning furnace as claimed in claim 1, wherein the filler material provides a catalytic action.

3. The VOC waste gas microwave burning furnace as claimed in claim 1, wherein the filler material has a physical property of high dielectric constant.

4. The VOC waste gas microwave burning furnace as claimed in claim 1, wherein each of the refractory ceramic/glass tubes has an inlet end corresponding to a conveying pipe outside the reaction tank, and an outlet end corresponding to an emission pipe outside the reaction tank.

5. The VOC waste gas microwave burning furnace as claimed in claim 4, wherein the conveying pipe is connected at a front end thereof and the emission pipe is connected at a terminal end thereof to a computerized recording and controlling apparatus each.

6. The VOC waste gas microwave burning furnace as claimed in claim 4, wherein the conveying pipe has a front end, at where organic waste gas is introduced into the conveying pipe.

7. The VOC waste gas microwave burning furnace as claimed in claim 4, wherein the emission pipe serves to discharge carbon dioxide and water vapors produced during reaction in the reaction tank.

8. The VOC waste gas microwave burning furnace as claimed in claim 1, wherein the carrier is provided at a bottom with a plurality of downward extended legs.

9. The VOC waste gas microwave burning furnace as claimed in claim 1, wherein the carrier is provided at predetermined positions with a gas inlet and a gas outlet.

10. The VOC waste gas microwave burning furnace as claimed in claim 1, wherein the refractory ceramic glass tubes are refractory precision ceramic glass tubes.
